(19) United States
(12) Patent Application Publication
(10) Pub. No.: US 2018/0306960 A1
(43) Pub. Date: Oct. 25, 2018

(54) BACKLIGHT MODULES AND LIQUID CRYSTAL DISPLAYS

(71) Applicant: Wuhan China Star Optpelectronics Technology Co., Ltd., Wuhan,Hubei (CN)

(72) Inventor: Guowei ZHA, Shenzhen, Guangdong (CN)

(73) Assignee: Wuhan China Star Optoelectronics Technology Co., Ltd., Wuhan, Hubei (CN)

(21) Appl. No.: 15/533,647

(22) PCT Filed: May 25, 2017
(86) PCT No.: PCT/CN2017/085861

§ 371 Date: Jun. 6, 2017

(30) Foreign Application Priority Data
Apr. 25, 2017 (CN) 201710276898.9

(51) Int. Cl. F21V 8/00; G02F 1/1333

(52) U.S. Cl. CPC G02B 6/0016; G02B 6/002; G02F 2001/133317; G02B 6/0083; G02F 1/133308; G02B 6/0091

(57) ABSTRACT

The present disclosure relates to a backlight module and a liquid crystal display (LCD) device. The backlight module includes a light guide plate is configured with a first area and a second area. A light incident surface is configured on a side of the second area of the light guide plate, wherein the side of the second area is adjacent to the first area. A diffraction grating configured within the first area, and the light source is configured below the diffraction grating. The diffraction grating is configured to diffract light beams emitted from the light source and to guide the light beams to enter the second area of the light guide plate via the light incident surface at a predetermined polar angle.

### BACKGROUND OF THE INVENTION

### 1. Field of the Invention

The present disclosure relates to display field, and more particularly to a backlight module and a liquid crystal display (LCD).

### 2. Discussion of the Related Art

The backlight module of the LCD includes edge-lighting type backlight module and bottom-lighting type backlight module.

As shown in FIG. 1, in the structure of the edge-lighting type backlight module, a light source 11 is configured on a side of a light guide plate 12. Light beams emitted from the light source 11 enter the light guide plate 12 via a light incident surface of the light guide plate 12. The light beams diffuse within the light guide plate 12 and emit from the light emitting surface of the light guide plate 12. Afterward, the light beams pass through a variety of optical films 13, such as diffuser, to form a uniform surface light source and the uniform surface light source is supplied to a liquid crystal panel 14. The light beams emitted from the light source 11 are divergent light beams, and are difficult to localize within the light guide plate 12, i.e., difficult to realize local dimming.

As shown in FIG. 2, in the structure of the bottom-lighting type backlight module, the light source 21 is configured on a bottom of the light guide plate 22. The light beams emitted from the light source 21 pass through the light guide plate 22 and a variety of optical films 23 to form uniform surface light source and the uniform surface light source is supplied to the liquid crystal panel 24. The bottom-lighting type backlight module may realize local dimming by controlling the light source 21 configured below the light guide plate 22. To ensure the display quality of the local dimming, a light-mixing distance is required to be configured between the light source 21 and the light guide plate 22, so as to mix the light beams emitted from the light source 21 sufficiently, and to ensure the uniform brightness within the display area. However, the configuration of the light-mixing distance is harmful to the lightweight requirement of the backlight module.

### SUMMARY

The present disclosure relates to a backlight module and a liquid crystal display (LCD) device capable of controlling the brightness of each area and meeting the lightweight requirement of the backlight module.

In one aspect, the present disclosure relates to a backlight module, including: a plurality of brightness control areas arranged in matrix, wherein each of the brightness control areas is configured with a light guide plate and a light source, and the light guide plate is configured with a first area and a second area arranged along a direction parallel to the light guide plate; a width of the first area of the light guide plate being smaller than a width of the second area of the light guide plate; a predetermined distance being configured between a bottom of the first area and a bottom of the second area of the light guide plate along a vertical direction; a diffraction grating configured within the first area of the light guide plate, wherein the light source configured with at least one micro light emitting diode (Micro LED), and the light source is configured below the diffraction grating; a light incident surface configured on a side of the second area of the light guide plate, wherein the side of the second area is adjacent to the first area, and the light incident surface is adjacent to the light source; wherein the diffraction grating is configured to diffract light beams emitted from the light source and to guide the light beams to enter the second area of the light guide plate via the light incident surface at a predetermined polar angle.

In another aspect, the present disclosure further relates to a backlight module, including: a light guide plate configured with a first area and a second area arranged along a direction parallel to the light guide plate; a light source; a diffraction grating configured within the first area of the light guide plate, wherein the light source configured with at least one Micro LED, and the light source is configured below the diffraction grating; a light incident surface configured on a side of the second area of the light guide plate, wherein the side of the second area is adjacent to the first area; wherein the diffraction grating is configured to diffract light beams emitted from the light source and to guide the light beams to enter the second area of the light guide plate via the light incident surface at a predetermined polar angle.

In another aspect, the present disclosure further relate to a LCD device, including: a light guide plate configured with a first area and a second area arranged along a direction parallel to the light guide plate; a light source; a diffraction grating configured within the first area of the light guide plate, wherein the light source configured with at least one Micro LED, and the light source is configured below the diffraction grating; a light incident surface configured on a side of the second area of the light guide plate, wherein the side of the second area is adjacent to the first area; wherein the diffraction grating is configured to diffract light beams emitted from the light source and to guide the light beams to enter the second area of the light guide plate via the light incident surface at a predetermined polar angle.

In view of the above, the diffraction grating is configured on the first area of the light guide plate, and the light incident surface configured on the side of the second area of the light guide plate, wherein the side of the second area is adjacent to the first area. The light guide plate of the second area may be regarded as the edge-lighting type light guide plate. The light beams may be guided along the vertical direction to enter the edge-lighting type light guide plate via the diffraction grating, and thus a light mixing distance in the bottom-lighting type backlight module may not be necessary. As such, the brightness control of each area may be simplified, and may meet the lightweight requirement of the backlight module.

### BRIEF DESCRIPTION OF THE DRAWINGS

FIG. 1 is a schematic view of a LCD having a conventional edge-lighting backlight module.

FIG. 2 is a schematic view of a LCD having a conventional bottom-lighting backlight module.

FIG. 3 is a schematic view of a backlight module in first embodiment of the present disclosure.

FIG. 4 is a top view of the backlight module shown in FIG. 3.

FIG. 5 is a schematic view of a backlight module in second embodiment of the present disclosure.

FIG. 6 is a top view of the backlight module shown in FIG. 5.

FIG. 7 is a schematic view of a LCD device in one embodiment of the present disclosure.

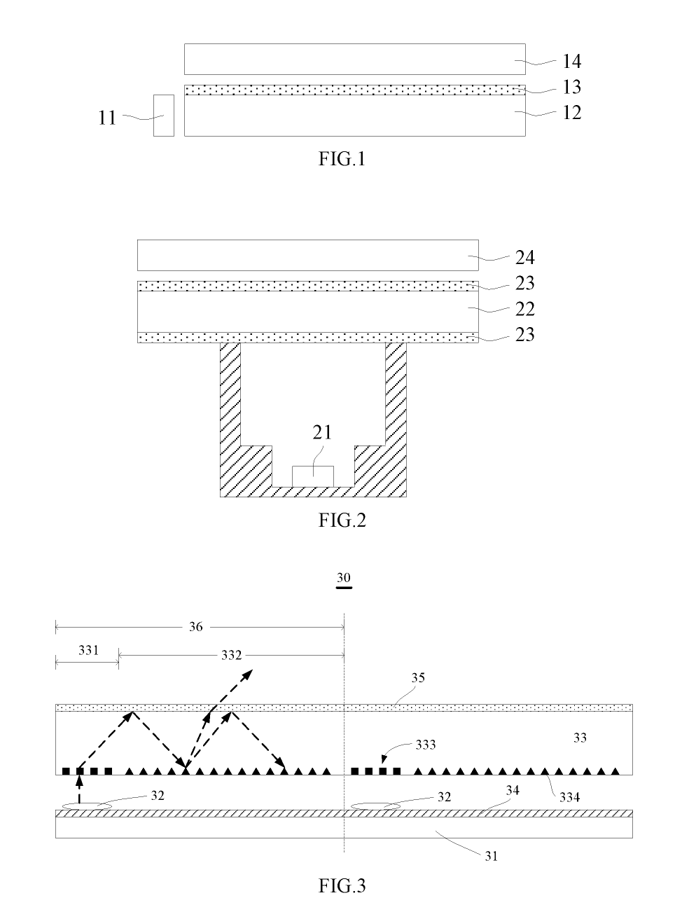

### DETAILED DESCRIPTION OF THE EMBODIMENTS

To clarify the purpose, technical solutions, and the advantages of the disclosure, embodiments of the invention will now be described more fully hereinafter with reference to the accompanying drawings, in which embodiments of the invention are shown. The figure and the embodiment described according to figure are only for illustration, and the present disclosure is not limited to these embodiments.

The present disclosure relates to a backlight module, as shown in FIG. 3, the backlight module 30 includes: a back plate 31 configured to carry a plurality of light source 32, a light guide plate 33, a driving circuit 34, and a variety of optical films 35. The light source 32 connects with the driving circuit 34. In one example, the driving circuit 34 is a flexible printed circuit board (FPCB). The driving circuit 34 is configured on a side adjacent to the light guide plate 33, and the driving circuit 34 is configured to separately control brightness and switches of each of the light sources. The light guide plate 33 and the optical films 35 are configured on a top of the light source 32. The light guide plate 33 and the optical films 35 are configured to transform light beams transmitted from the light source 32 into a uniform surface light source, and configured to supply the uniform surface light source to a liquid crystal panel on a light emission surface of the light guide plate 33. In one example, the optical films 35 may include, but is not limited to, a diffuser and a polarizer.

The light guide plate 33 is configured with a first area 331 and a second area 332 arranged in sequence along a direction parallel to the light guide plate 33, wherein the first area 331 and the second area 332 are interleaved with each other. A width of the first area 331 is smaller than a width of the second area 332. A thickness of the first area 331 of the light guide plate equals to a thickness of the second area 332 of the light guide plate. The light guide plate 33 is configured with a diffraction grating 333 arranged on a bottom of the first area 331 of the light guide plate 33. Each of the light sources is configured below the corresponding diffraction grating 333. A light incident surface configured on a side of the second area 332 of the light guide plate 33, wherein the side of the second area 332 is adjacent to the first area 331, i.e., the light incident surface is configured on the side of the second area 332 of the light guide plate 33. The light guide plate 33 of the second area 332 may be regarded as an edge-lighting type light guide plate. Wherein, the light guide plate 33 is an integral structure, the first area 331 and the second area 332 interconnect with each other, and the first area 331 and the second area 332 have the same refractive index. Therefore, the light incident surface is not a side exposed to the environment.

The diffraction grating 333 is configured to diffract light beams emitted from the light source 32 and to guide the light beams to enter the second area 332 of the light guide plate 33 via the light incident surface at a predetermined polar angle. That is, the diffraction grating 333 is configured to transform the light beams emitted from the light source 32 along a vertical direction into a non-vertical direction, the diffraction grating 333 is configured to diffract light beams emitted from the light source 32, the diffraction grating 333 is configured to guide only the light beams having a first order diffraction peak to enter a visual zone, and the diffraction grating 333 is configured to exclude other orders of diffraction peak out of the visual zone, i.e., after the light beams pass through the diffraction grating 333 (emission light beams), only the light beams having the first order diffraction peak may enter the second area 332 of the light guide plate 33 via the light incident surface at the predetermined polar angle. According to the operating principle of the diffraction grating 333, polar coordinates (φ1, θ1) of the first order diffraction peak of the emission light beams satisfy the following relationship.

tan φ1=sin φ/(cos φ−N*sin θ*(Λ/λ)

sin 2(θ1)=(Λ/λ)2+(N*sin φ)2−2N*sin θ*cos φ*(λ/Λ)

Wherein, φ1 is a diameter of the emission light beams, θ1 is a polar angle of the emission light beams, Λ is a period of the diffraction grating 333, φ is an azimuth of the emission light beams, N is the refractive index of the light guide plate 33, θ is a polar angle that the light beams enter the diffraction grating 333 (incident light beams), and λ is a wavelength of the incident light beams.

In view of the above, the light beams are diffracted and only the light beams having the first diffraction peak is guided to enter the visual zone by passing through the light guide plate having a predetermined refractive index.

In one example, a top surface of the first area 331 of the light guide plate 33 may total reflect the light beams which have been diffracted and have the predetermined polar angle, so as to avoid the light beams to be emitted to the environment from the top surface of the first area 331 of the light guide plate 33, and to improve light utilization rate.

A structure of the second area 332 of the light guide plate 33 is same with the conventional structure of the edge-lighting light guide plate. For example, a bottom of the second area 332 of the light guide plate 33 may configured with a plurality of hit points 334. The light beams enter the second area 332 at the predetermined polar angle, irradiate to each of the hit points 334, and diffuse. The diffused light beams are emitted via the light emission surface of the second area 332 of the light guide plate 33. The diffused light beams pass through the optical films 35 to form the uniform surface light source, and the uniform surface light source is supplied to the liquid crystal panel.

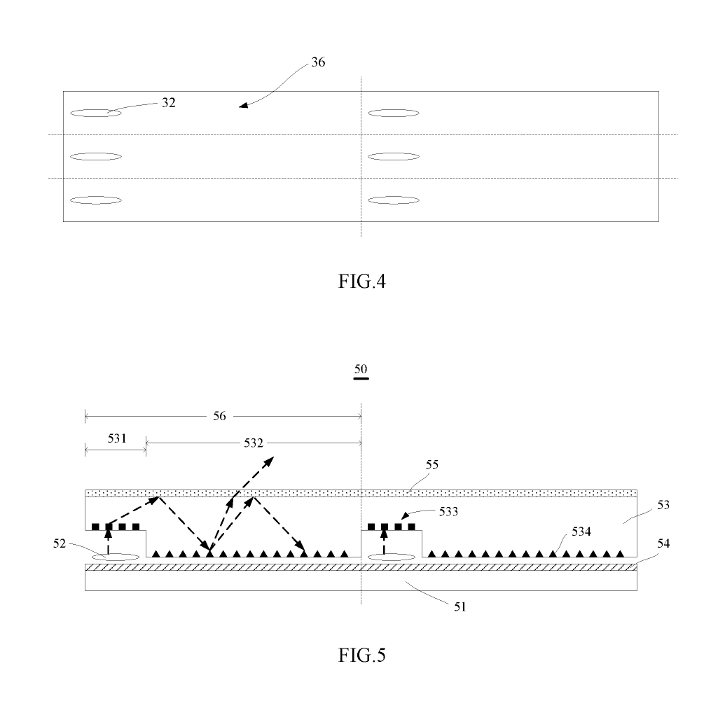

As shown in FIG. 4, the backlight module 30 includes a plurality of brightness control areas 36 arranged in matrix, wherein each of the brightness control areas 36 is configured with the light source 32, the first area 331, and the second area 332. The driving circuit 34 is configured to separately control each of the light sources 32 to adjust the brightness of each of the brightness control areas 36, so as to simplify the brightness control of each area.

In the view of the above, the present disclosure may guide the light beams along the vertical direction to enter the edge-lighting type light guide plate (the second area 332 of the light guide plate 33) via the diffraction grating 333, and thus a light mixing distance in the bottom-lighting type backlight module may not be necessary. As such, the brightness control of each area may be simplified, and may meet the lightweight requirement of the backlight module 30.

In one example, the light source 32 may adopt Micro light emitting diode (Micro LED), i.e., the LED having a micron-sized thickness, so as to further reduce a thickness of the backlight module 30, and to meet the lightweight requirement of the backlight module 30.

As shown FIG. 3, the present disclosure relates to the backlight module 50, including: the back plate 51 configured to carry the light sources 52, the light guide plate 53, the driving circuit 54, and optical films 55. The light source 52 connects with the driving circuit 54. In one example, the driving circuit 54 is the FPCB. The driving circuit 54 is configured on the side adjacent to the light guide plate 53, and the driving circuit 54 is configured to separately control brightness and switches of each of the light sources. The light guide plate 53 and the optical films 55 are configured on the top of the light source 52. The light guide plate 53 and the optical films 55 are configured to transform light beams transmitted from the light source 52 into the uniform surface light source, and configured to supply the uniform surface light source to the liquid crystal panel on the light emission surface of the light guide plate 53. In one example, the optical films 35 may include, but is not limited to, the diffuser and the polarizer.

The light guide plate 53 is configured with the first area 531 and the second area 532. The width of the first area 531 is smaller than the width of the second area 532. The thickness of the first area 531 of the light guide plate equals to the thickness of the second area 532 of the light guide plate. That is, a predetermined distance is configured between the bottom of the first area 531 and the bottom of the second area 532 of the light guide plate 53 along the vertical direction. The light guide plate 53 is configured with the diffraction grating 533 arranged on the bottom of the first area 531 of the light guide plate 53. Each of the light sources is configured below the corresponding diffraction grating 533. The light incident surface configured on the side of the second area 532 of the light guide plate 53, wherein the side of the second area 532 is adjacent to the first area 531, i.e., the light incident surface is configured on the side of the second area 532 of the light guide plate 53. The light guide plate 53 of the second area 532 may be regarded as the edge-lighting type light guide plate. Wherein, the light guide plate 53 is the integral structure, the first area 531 and the second area 532 interconnect with each other, and the first area 531 and the second area 532 have the same refractive index.

The diffraction grating 533 is configured to diffract light beams emitted from the light source 52 and to guide the light beams to enter the second area 532 of the light guide plate 53 via the light incident surface at the predetermined polar angle.

The structure of the second area 532 of the light guide plate 53 is same with the conventional edge-lighting light guide plate. For example, the bottom of the second area 532 of the light guide plate 33 may configured with the hit points 534. The light beams enter the second area 532 at the predetermined polar angle, irradiate to each of the hit points 534, and diffuse. The diffused light beams are emitted via the light emission surface of the second area 532 of the light guide plate 33. The diffused light beams pass through the optical films 55 to form the uniform surface light source, and the uniform surface light source is supplied to the liquid crystal panel.

The difference between this embodiment and the embodiment shown in FIG. 3 relies in that a slot is configured on a top of the light source 52, and the slot corresponds to the light source 52. The light guide plate 53 is configured on the light incident surface of the second area 532, and the light guide plate 53 is adjacent to the light source 52. Therefore, the second area 532 may not only receive the light beams from the diffraction grating 533, but also may receive the light beams directly from the light source 52, so as to improve the light utilization rate.

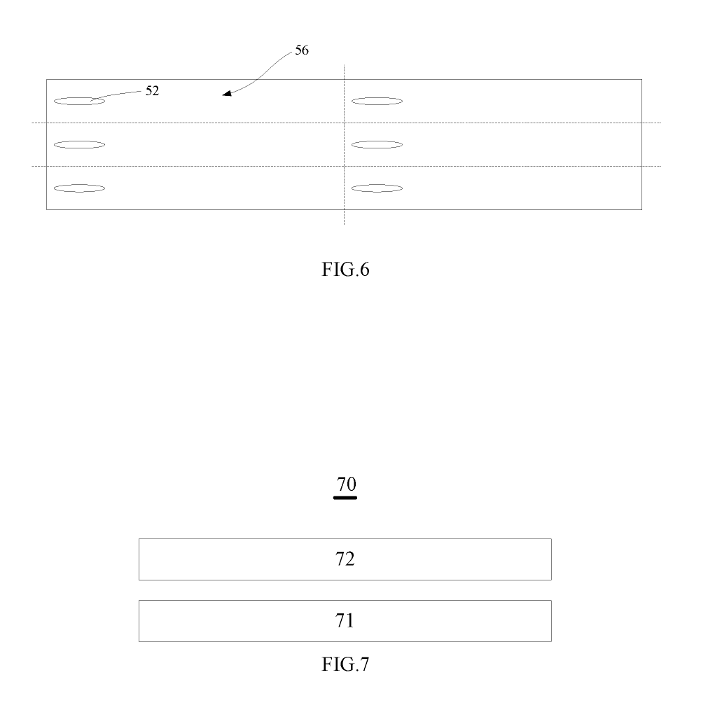

As shown in FIG. 6, the backlight module 60 includes brightness control areas 66 arranged in matrix, wherein each of the brightness control areas 66 is configured with the light source 52, the first area 531, and the second area 532. The driving circuit 54 is configured to separately control each of the light sources 52 to adjust the brightness of each of the brightness control areas 56, so as to simplify the brightness control of each area.

In the view of the above, the present disclosure may guide the light beams along the vertical direction to enter the edge-lighting type light guide plate (the second area 332 of the light guide plate 33) via the diffraction grating 533, and thus the light mixing distance in the bottom-lighting type backlight module may not be necessary. As such, the brightness control of each area may be simplified, and may meet the lightweight requirement of the backlight module 50.

In one example, the light source 52 may adopt Micro LED, so as to further reduce the thickness of the backlight module 50, and to meet the lightweight requirement of the backlight module 50.

In one example, the backlight module in the present disclosure may further includes a plastic frame surrounding the light guide plate, wherein the plastic frame is configured to fix the liquid crystal panel on the light emission surface of the light guide plate. The light guide plate may be made of polycarbonate (PC) material or glass. Due to the light beams may diffuse better in the glass than in the PC, the light beams may have a shorter path of refraction in the glass than in the PC with the same uniformity in transforming a point light source into the surface light source. Thus, the thickness of the light guide plate may be further reduced by adopting the glass material, and the thickness of the backlight module may be further reduced.

In another aspect, the present disclosure further relates to a liquid crystal display (LCD) device. As shown in FIG. 7, the LCD device 70 includes the backlight module 71 and the liquid crystal panel 72 arranged on the backlight module 71 along a light emission direction. In one example, the backlight module 71 may be the backlight module 30 shown in FIG. 3. In another example, the backlight module 71 may be the backlight module 50 shown in FIG. 5. Therefore, the LCD device 70 may include the beneficial effects that the backlight modules 30, 50 may have.

The above description is only the embodiments in the present disclosure, the claim is not limited to the description thereby. The equivalent structure or changing of the process of the content of the description and the figures, or to implement to other technical field directly or indirectly should be included in the claim.

What is claimed is:

1. A backlight module, comprising:
a plurality of brightness control areas arranged in matrix, wherein each of the brightness control areas is configured with a light guide plate and a light source, and the light guide plate is configured with a first area and a second area arranged along a direction parallel to the light guide plate;
a width of the first area of the light guide plate being smaller than a width of the second area of the light guide plate;
a predetermined distance being configured between a bottom of the first area and a bottom of the second area of the light guide plate along a vertical direction;
a diffraction grating configured within the first area of the light guide plate, wherein the light source configured with at least one micro light emitting diode (Micro LED), and the light source is configured below the diffraction grating;
a light incident surface configured on a side of the second area of the light guide plate, wherein the side of the second area is adjacent to the first area, and the light incident surface is adjacent to the light source;
wherein the diffraction grating is configured to diffract light beams emitted from the light source and to guide the light beams to enter the second area of the light guide plate via the light incident surface at a predetermined polar angle.

2. The backlight module according to claim 1, wherein the backlight module further comprises:
a back plate configured to carry the light guide plate, a driving circuit, and the light source;
the driving circuit configured to separately control the light source of the backlight module;
a plastic frame surrounds the light guide plate, wherein the plastic frame is configured to fix a liquid crystal panel on a light emission surface of the light guide plate.

3. A backlight module, comprising:
a light guide plate configured with a first area and a second area arranged along a direction parallel to the light guide plate;
a light source;
a diffraction grating configured within the first area of the light guide plate, wherein the light source configured with at least one Micro LED, and the light source is configured below the diffraction grating;
a light incident surface configured on a side of the second area of the light guide plate, wherein the side of the second area is adjacent to the first area;
wherein the diffraction grating is configured to diffract light beams emitted from the light source and to guide the light beams to enter the second area of the light guide plate via the light incident surface at a predetermined polar angle.

4. The backlight module according to claim 3, wherein the light source comprises at least one Micro LED.

5. The backlight module according to claim 3, wherein a thickness of the first area of the light guide plate equals to a thickness of the second area of the light guide plate.

6. The backlight module according to claim 3, wherein a width of the first area of the light guide plate is smaller than a width of the second area of the light guide plate, and a predetermined distance is configured between a bottom of the first area and a bottom of the second area of the light guide plate along a vertical direction.

7. The backlight module according to claim 6, wherein the light incident surface of the second area is adjacent to the light source.

8. The backlight module according to claim 3, wherein the backlight module further comprises a back plate configured to carry the light guide plate and the light source.

9. The backlight module according to claim 8, wherein the backlight module comprises:
a plurality of brightness control areas arranged in matrix, wherein each of the brightness control areas is configured with the light source;
a driving circuit configured on the back plate, wherein the driving circuit is configured to separately control the light source of the backlight module.

10. The backlight module according to claim 3, wherein the backlight module further comprises a plastic frame surrounds the light guide plate, and the plastic frame is configured to fix a liquid crystal panel on a light emission surface of the light guide plate.

11. The backlight module according to claim 3, wherein the light guide plate is made of glass or polycarbonate (PC).

12. A liquid crystal display (LCD) device, comprising: a backlight module, the backlight module comprising:
a light guide plate configured with a first area and a second area arranged along a direction parallel to the light guide plate;
a light source;
a diffraction grating configured within the first area of the light guide plate, wherein the light source configured with at least one Micro LED, and the light source is configured below the diffraction grating;
a light incident surface configured on a side of the second area of the light guide plate, wherein the side of the second area is adjacent to the first area;
wherein the diffraction grating is configured to diffract light beams emitted from the light source and to guide the light beams to enter the second area of the light guide plate via the light incident surface at a predetermined polar angle.

13. The LCD device according to claim 12, wherein the light source comprises at least one Micro LED.

14. The LCD device according to claim 12, wherein a thickness of the first area of the light guide plate equals to a thickness of the second area of the light guide plate.

15. The LCD device according to claim 12, wherein a width of the first area of the light guide plate is smaller than a width of the second area of the light guide plate, and a predetermined distance is configured between a bottom of the first area and a bottom of the second area of the light guide plate along a vertical direction.

16. The LCD device according to claim 15, wherein the light incident surface of the second area is adjacent to the light source.

17. The LCD device according to claim 12, wherein the backlight module further comprises a back plate configured to carry the light guide plate and the light source.

18. The LCD device according to claim 17, wherein the backlight module comprises:
a plurality of brightness control areas arranged in matrix, wherein each of the brightness control areas is configured with the light source;
a driving circuit configured on the back plate, wherein the driving circuit is configured to separately control the light source of the backlight module.

19. The LCD device according to claim 12, wherein the backlight module further comprises a plastic frame surrounds the light guide plate, and the plastic frame is configured to fix a liquid crystal panel on a light emission surface of the light guide plate.

20. The LCD device according to claim 12, wherein the light guide plate is made of glass or PC.
